(19) United States
(12) Patent Application Publication
(10) Pub. No.: US 2023/0158631 A1
(43) Pub. Date: May 25, 2023

(54) ANGLE GRINDER

(71) Applicant: MILWAUKEE ELECTRIC TOOL CORPORATION, Brookfield, WI (US)

(72) Inventors: Karly M. Schober, Milwaukee, WI (US); Terry L. Timmons, Oconomowoc, WI (US); Jarrod P. Kotes, Grafton, WI (US)

(21) Appl. No.: 18/057,856

(22) Filed: Nov. 22, 2022

Related U.S. Application Data
(60) Provisional application No. 63/282,713, filed on Nov. 24, 2021.

(51) Int. Cl. B24B 23/02

(52) U.S. Cl. CPC B24B 23/028; B24B 23/022; B24B 47/12

(57) ABSTRACT

An angle grinder is disclosed and includes a housing, a motor within the housing, a gearcase extending from the housing, wherein the gearcase includes a spindle and the spindle is driven by the motor, a rotating tool removable engaged with the spindle, a flange removably engaged with the spindle to secure the rotating tool on the spindle, and a flange retainer disposed on the grinder, wherein the flange retainer is configured to receive and retain the flange when the flange is disengaged from the spindle.

### CROSS-REFERENCE TO RELATED APPLICATIONS

This application claims priority to co-pending U.S. Provisional Patent Application No. 63/282,713 filed on Nov. 24, 2021, the entire content of which is incorporated herein by reference.

### FIELD

The present disclosure relates to abrasive tools, and more particularly to battery powered angle grinders.

### BACKGROUND

Angle grinders are standard tools in most machine shops. Depending on the application, angled grinders may be used with thin cut-off discs, abrasive discs, sanding discs, wire brushes, etc. in order to cut a workpiece, grind a workpiece, sand a workpiece, or clean a workpiece (e.g., with a brush).

### SUMMARY

The present disclosure provides, in one aspect, an angle grinder includes a housing, a motor within the housing, a gearcase extending from the housing, wherein the gearcase includes a spindle and the spindle is driven by the motor, a rotating tool removable engaged with the spindle, a flange removably engaged with the spindle to secure the rotating tool on the spindle, and a flange retainer disposed on the grinder, wherein the flange retainer is configured to receive and retain the flange when the flange is disengaged from the spindle.

The present disclosure provides, in another aspect, an angle grinder includes a housing, a motor within the housing, a gearcase extending from the housing, wherein the gearcase includes a spindle and the spindle is driven by the motor, a rotating tool removable engaged with the spindle, a flange removably engaged with the spindle to secure the rotating tool on the spindle, and a flange retainer disposed on the grinder, wherein the flange retainer is a generally U-shaped spring clip that receives and retains the flange when the flange is disengaged from the spindle.

The present disclosure provides, in still another aspect, an angle grinder having a housing, a motor within the housing, a gearcase extending from the housing, wherein the gearcase includes a spindle and the spindle is driven by the motor, a rotating tool removable engaged with the spindle, a guard mounted on the gearcase and at least partially surrounds the rotating tool, a flange removably engaged with the spindle to secure the rotating tool on the spindle, and a flange retainer disposed on the guard, wherein the flange retainer is configured to receive and retain the flange when the flange is disengaged from the spindle.

Other features and aspects of the disclosure will become apparent by consideration of the following detailed description and accompanying drawings.

### BRIEF DESCRIPTION OF THE DRAWINGS

FIG. 1 is a perspective view of a first embodiment of an angle grinder in accordance with an embodiment of the present disclosure.

FIG. 2 is a top view of the first angle grinder in accordance with an embodiment of the present disclosure.

FIG. 3 is a first perspective view of a flange holder of the first angle grinder in accordance with an embodiment of the present disclosure.

FIG. 4 is a second perspective view of the flange holder of the first angle grinder in accordance with an embodiment of the present disclosure.

FIG. 5 is a perspective view of a second embodiment of an angle grinder in accordance with an embodiment of the present disclosure.

FIG. 6 is a top view of the second angle grinder in accordance with an embodiment of the present disclosure.

FIG. 7 is a first perspective view of a flange holder of the second angle grinder in accordance with an embodiment of the present disclosure.

FIG. 8 is a second perspective view of the flange holder of the second angle grinder in accordance with an embodiment of the present disclosure.

FIG. 9 is a perspective view of a third embodiment of an angle grinder in accordance with an embodiment of the present disclosure.

FIG. 10 is a side view of the third angle grinder in accordance with an embodiment of the present disclosure.

FIG. 11 is a perspective view of a flange holder of the third angle grinder in accordance with an embodiment of the present disclosure.

FIG. 12 is a perspective view of a fourth embodiment of an angle grinder in accordance with an embodiment of the present disclosure.

FIG. 13 is a side view of the fourth angle grinder in accordance with an embodiment of the present disclosure.

FIG. 14 is a perspective view of a flange holder of the fourth angle grinder in accordance with an embodiment of the present disclosure.

FIG. 15 is a perspective view of a fifth embodiment of an angle grinder in accordance with an embodiment of the present disclosure.

FIG. 16 is a top view of the fifth angle grinder in accordance with an embodiment of the present disclosure.

FIG. 17 is a perspective view of a flange holder of the fifth angle grinder in accordance with an embodiment of the present disclosure.

FIG. 18 is a perspective view of a sixth embodiment of an angle grinder in accordance with an embodiment of the present disclosure.

FIG. 19 is a top view of the sixth angle grinder in accordance with an embodiment of the present disclosure.

FIG. 20 is a perspective view of a flange holder of the sixth angle grinder in accordance with an embodiment of the present disclosure.

FIG. 21 is a partial side view of a seventh angle grinder in accordance with an embodiment of the present disclosure.

FIG. 22 is a partial end view of the seventh angle grinder in accordance with an embodiment.

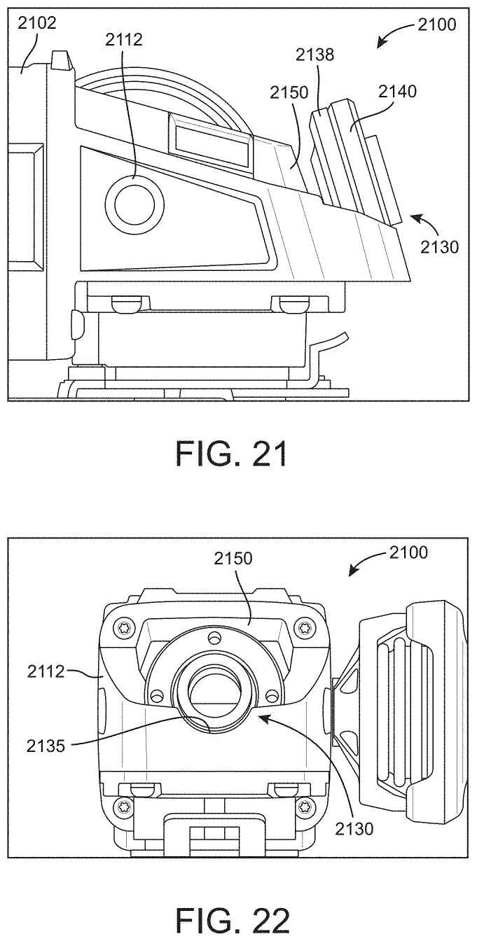

FIG. 21 is a partial side view of a seventh angle grinder in accordance with an embodiment of the present disclosure.

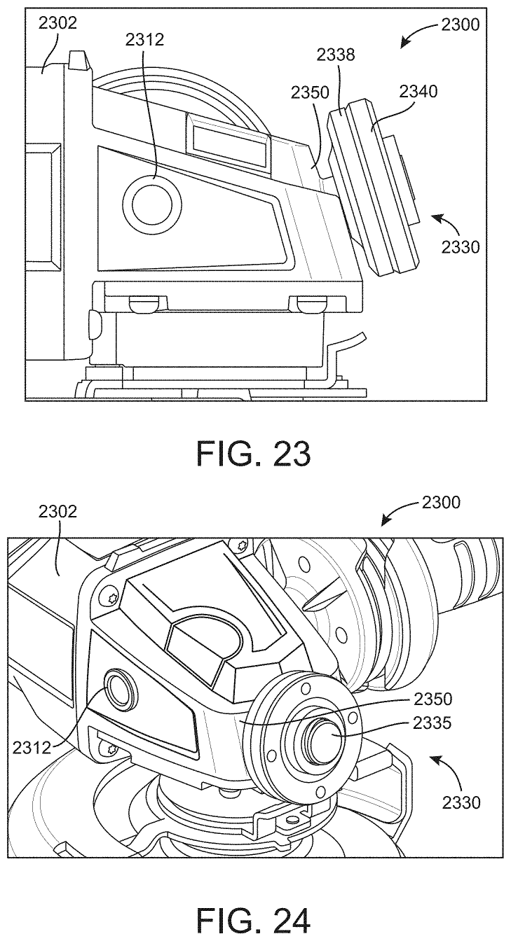

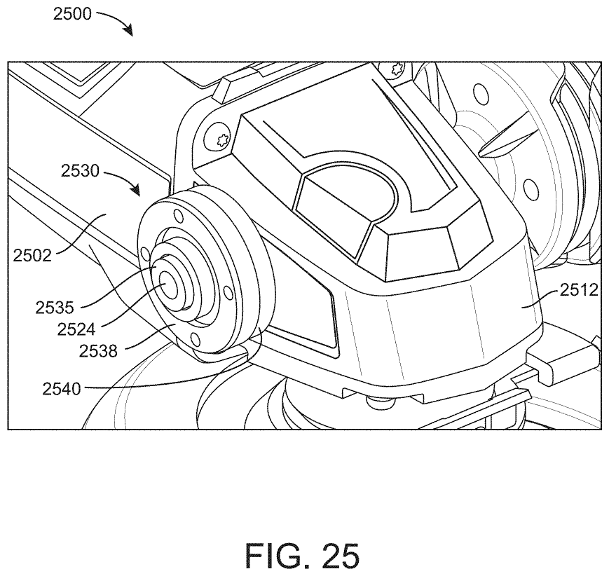

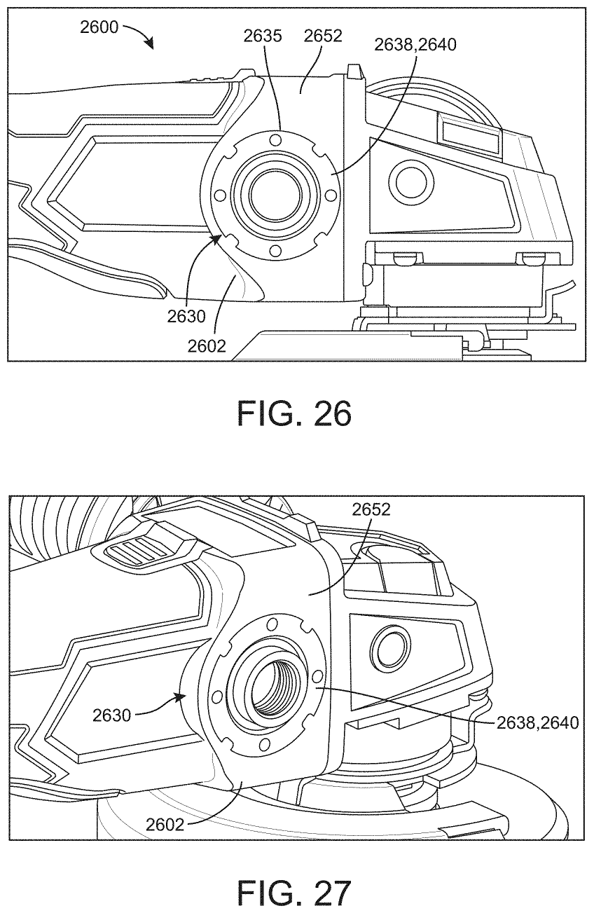

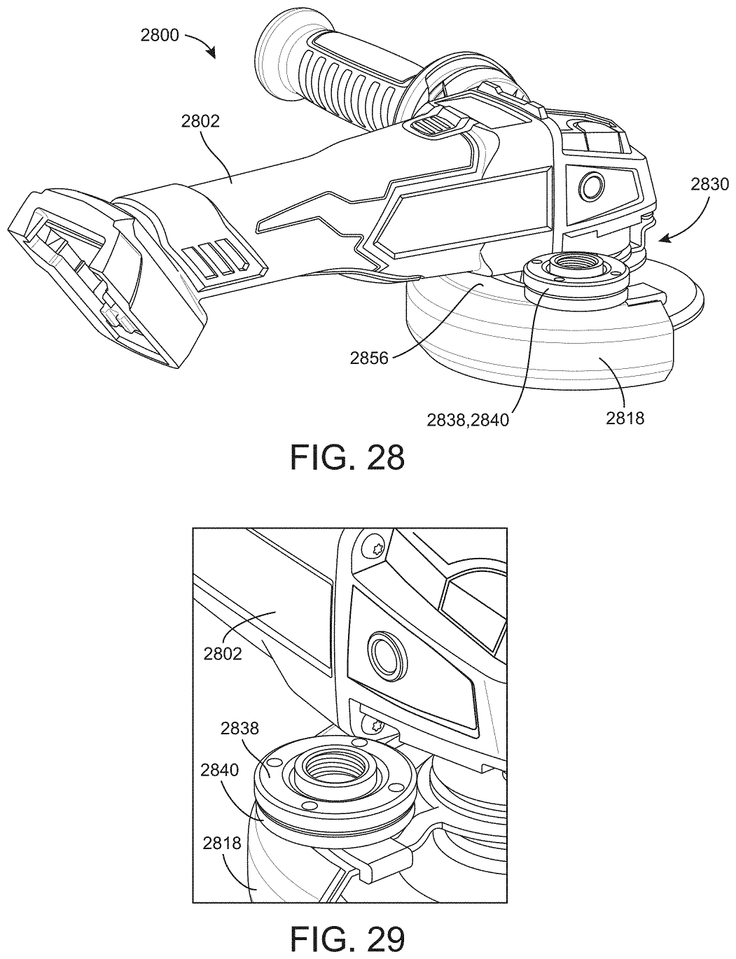

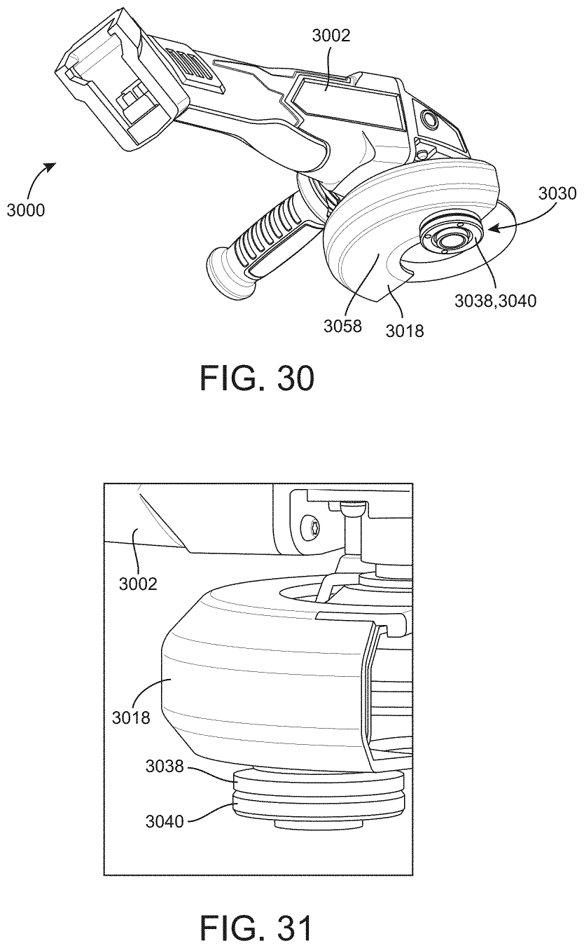

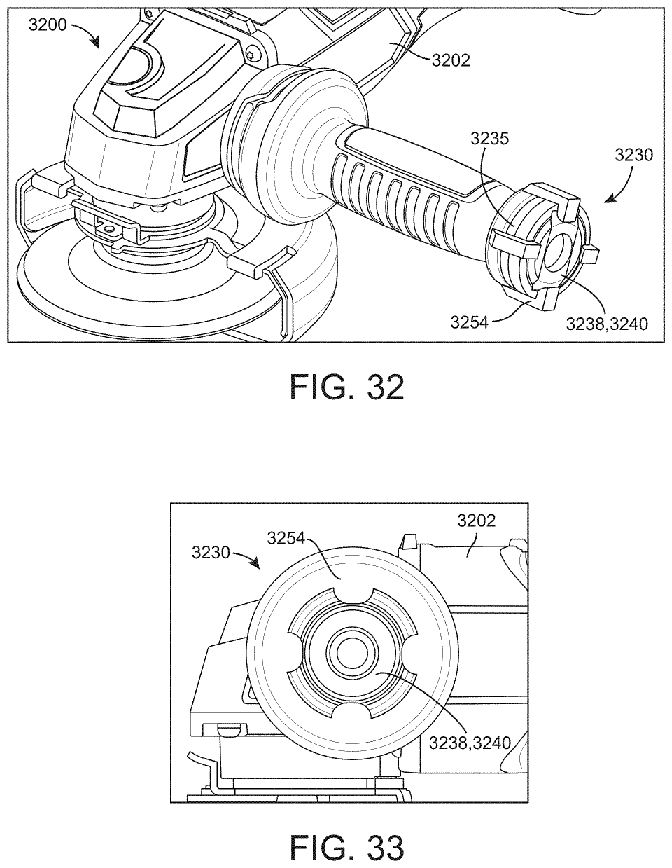

FIG. 22 is a partial end view of the seventh angle grinder in accordance with an embodiment.

FIG. 23 is a partial side view of an eighth angle grinder in accordance with an embodiment of the present disclosure.

FIG. 24 is a partial perspective view of the eighth angle grinder in accordance with an embodiment.

FIG. 25 is a perspective view of a ninth embodiment of an angle grinder in accordance with an embodiment of the present disclosure.

FIG. 26 is a side view of the tenth angle grinder in accordance with an embodiment of the present disclosure.

FIG. 27 is a perspective view of a flange holder of the tenth angle grinder in accordance with an embodiment of the present disclosure.

FIG. 28 is a perspective view of an eleventh embodiment of an angle grinder in accordance with an embodiment of the present disclosure.

FIG. 29 is a perspective view of a flange holder of the eleventh angle grinder in accordance with an embodiment of the present disclosure.

FIG. 30 is a perspective view of a twelfth embodiment of an angle grinder in accordance with an embodiment of the present disclosure.

FIG. 31 is a side view of a flange holder of the twelfth angle grinder in accordance with an embodiment of the present disclosure.

FIG. 32 is a partial perspective view of a thirteenth embodiment of an angle grinder in accordance with an embodiment of the present disclosure.

FIG. 33 is an end view of a flange holder of the thirteenth angle grinder in accordance with an embodiment of the present disclosure.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

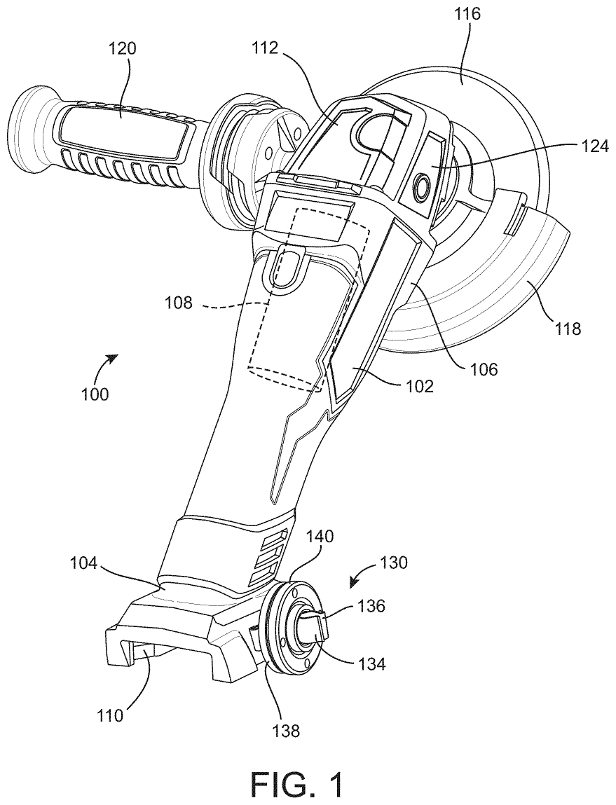

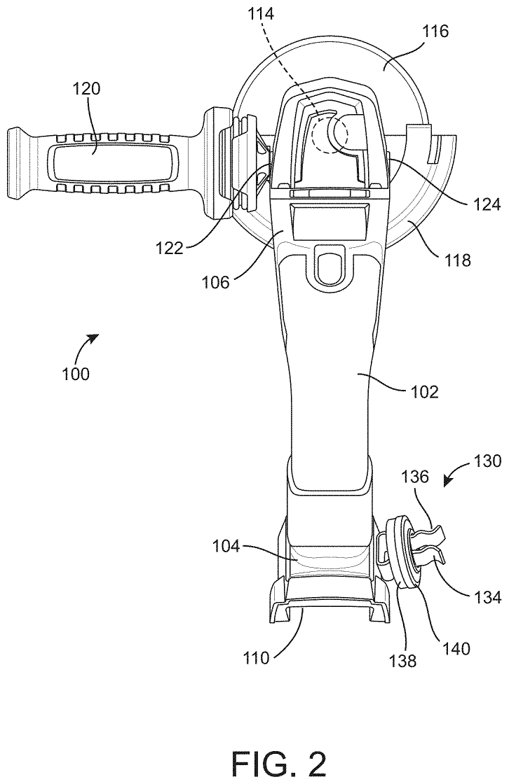

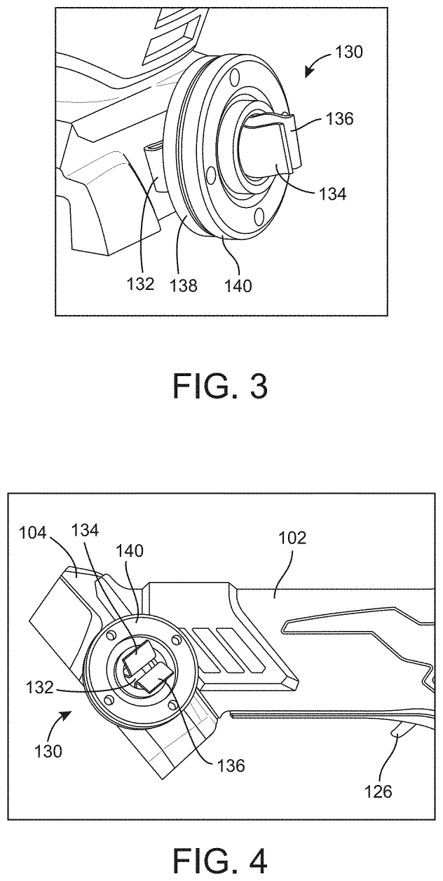

Referring to FIG. 1 through FIG. 4, a first embodiment of an angle grinder is illustrated and is generally designated 100. As shown, the angle grinder 100 includes a housing 102. The housing 102 defines a proximal end 104 and a distal end 106. A motor 108 is disposed, or otherwise installed, within the housing 102. The motor 108 is powered by a battery that is insertable into a battery receptacle 110 formed in the proximal end 104 of the housing 102. It is to be understood that the battery may be removably engaged with the battery receptacle 110 formed in the housing 102 (e.g., to facilitate charging).

FIGS. 1-4 illustrate that a gearcase 112 is attached to the distal end 106 of the housing 102. The gearcase 112 includes a spindle 114 that is driven by the motor 108. As shown, a rotating tool 116 (e.g., an abrasive disk, a thin cut-off disc, a sanding disc, a wire brush, etc.) is coupled to the spindle 114. The rotating tool 116 may be removable engaged with the spindle 114. The angle grinder 100 further includes a guard 118 that is mounted on the gearcase 112 and that at least partially surrounds the rotating tool 116. The guard 118 may protect a user from sparks and debris created while using the angle grinder 100 (e.g., to shape, clean, or cut a workpiece).

During operation, a user can grip the housing 102 of the angle grinder 100 and the housing 102 can act as a primary handle. To provide greater stability against torsional forces during use, the angle grinder 100 may include a side handle 120 (e.g., acting as a secondary handle) that is removably engaged with the gearcase 112. In a particular embodiment, the gearcase 112 includes a first handle attachment point 122 on a first side of the gearcase 112 and a second handle attachment point 124 on a second side of the gearcase 112 that is disposed opposite the first side. The handle attachment points 122, 124 may be formed with internal threads that are sized and shaped to engage corresponding male threads formed on a threaded shaft (not shown) that extends from an end of the handle 120. As shown in FIG. 4, the angle grinder 100 includes a power switch 126 that extends from the housing 102. A user may depress, or actuate, the power switch 126 to power on the angle grinder 100. On release of the power switch 126, the angle grinder 100 may be powered off.

With continued reference to FIGS. 1-4, the angle grinder 100 includes a flange retainer 130 that is mounted on the housing 102 at the proximal end 104. As illustrated, the flange retainer 130 is a generally U-shaped spring clip that includes a base 132. A first arm 134 extends in a generally perpendicular direction to the base 132. A second arm 136 also extends in a generally perpendicular direction to the base 132. The arms 134, 136 are formed with similarly-sized and shaped undulations, and the arms 134, 136 are spaced apart from each other so that a distance between the undulations varies from a value that corresponds to an inner diameter of one or more flanges 138, 140 that are removably engaged with the flange retainer 130 to a value that is greater than the inner diameter of the flanges 138, 140.

During use, the arms 134, 136 of the flange retainer 130 may be squeezed toward each other to reduce the distance between the undulations formed on the arms 134, 136. When released, the springiness of the arms 134, 136 may bias the arms 134, 136 away from each other and return the arms 134, 136 to the starting position. As shown, the flanges 138, 140 can be fitted over the arms 134, 136 of the flange retainer 130 and the outward spring force of the arms 134, 136, in conjunction with the undulations formed on the arms 134, 136, may retain the flanges 138, 140 on the flange retainer 130 until they are needed to hold the rotating tool 116 in place on the spindle 114 of the gearcase 112.

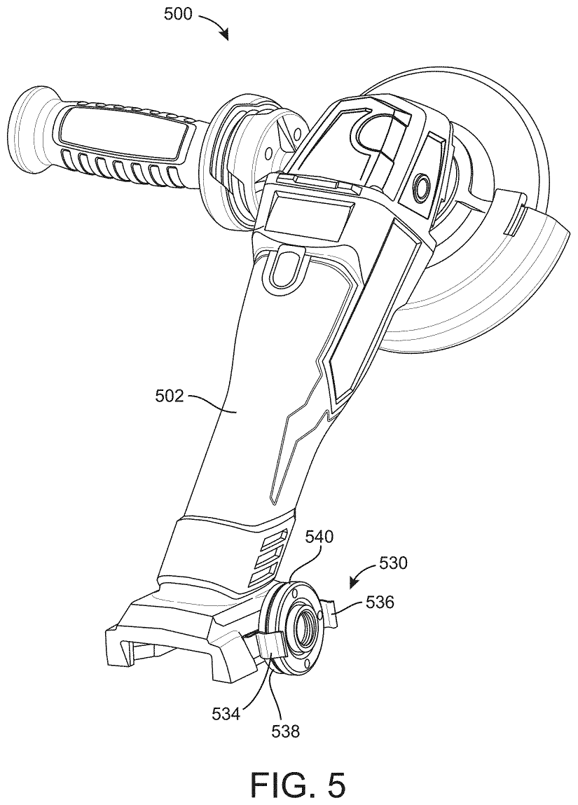

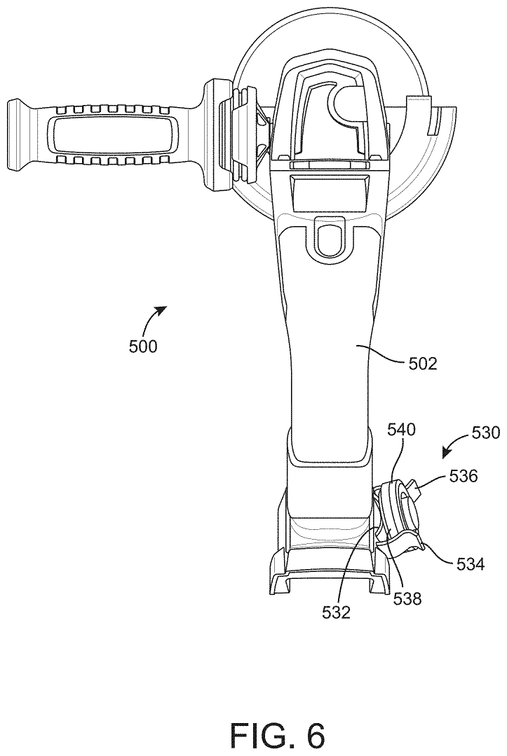

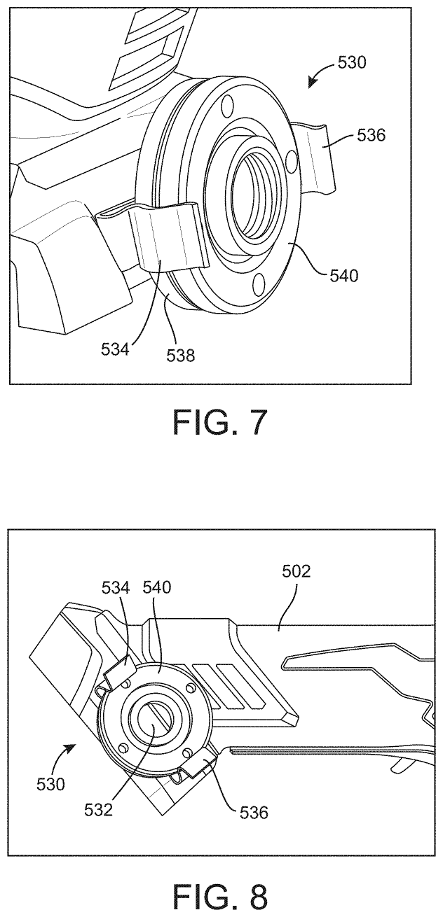

FIGS. 5-8 illustrate another exemplary angle grinder 500. The angle grinder 500 is substantially the same as the angle grinder 100 described and illustrated in FIGS. 1-4 except with regard to the construction of the flange retainer 530. As shown, the flange retainer 530 is affixed, or otherwise attached, to the proximal end 504 of the housing 502. The flange retainer 530 is a generally U-shaped spring clip that includes a base 532. A first arm 534 extends in a generally perpendicular direction to the base 532. A second arm 536 extends in a generally perpendicular direction to the base 532. The arms 534, 536 are formed with similarly sized and shaped undulations and the arms 534, 536 are spaced apart from each other so that a distance between the undulations varies from a value that corresponds to an outer diameter of one or more flanges 538, 540 that are removably engaged with the flange retainer 530 to a value that is less than the outer diameter of the flanges 538, 540.

During use, the arms 534, 536 of the flange retainer 530 may be flexed away from each other to increase the distance between the undulations formed on the arms 534, 536. When released, the springiness of the arms 534, 536 may bias the arms 534, 536 toward each other back to the starting position. As shown, the flanges 538, 540 can be fitted between the arms 534, 536 of the flange retainer 530 and the inward spring force of the arms 534, 536, in conjunction with the undulations formed on the arms 534, 536, may retain the flanges 538, 540 on the flange retainer 530 until they are needed to hold the rotating tool 516 in place on the spindle 514 of the gearcase 512.

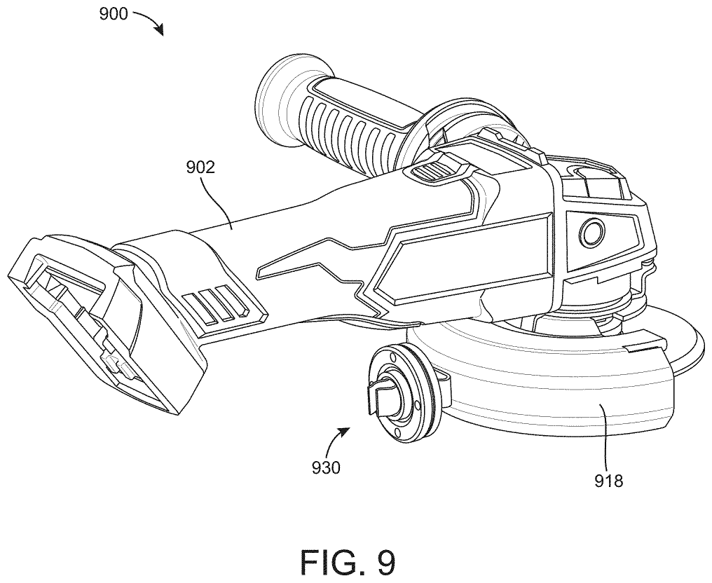

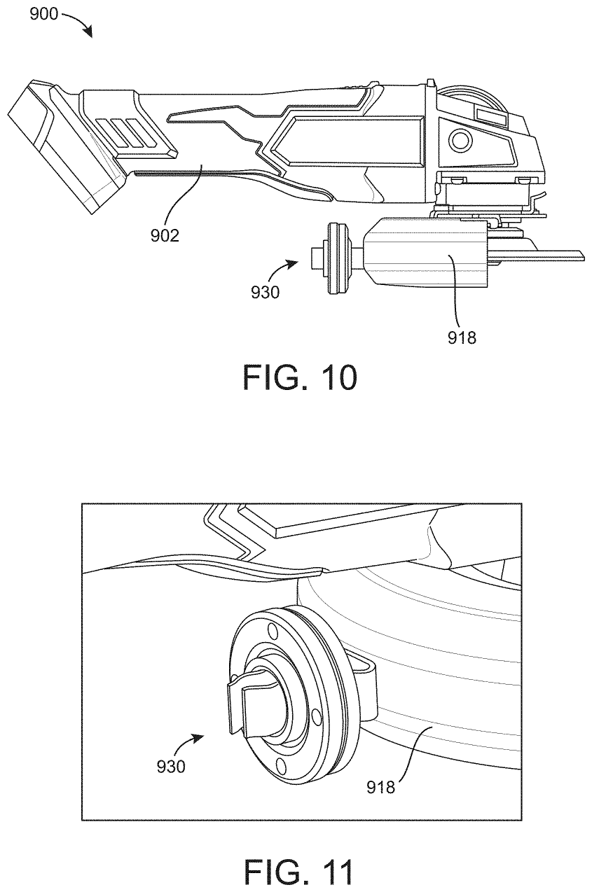

FIGS. 9-11 illustrate another exemplary angle grinder 900 that is substantially the same as the angle grinder 100 except for the placement or location of the flange retainer 930. As shown, the flange retainer 930 is affixed, or otherwise attached, to the guard 918 of the angle grinder 900.

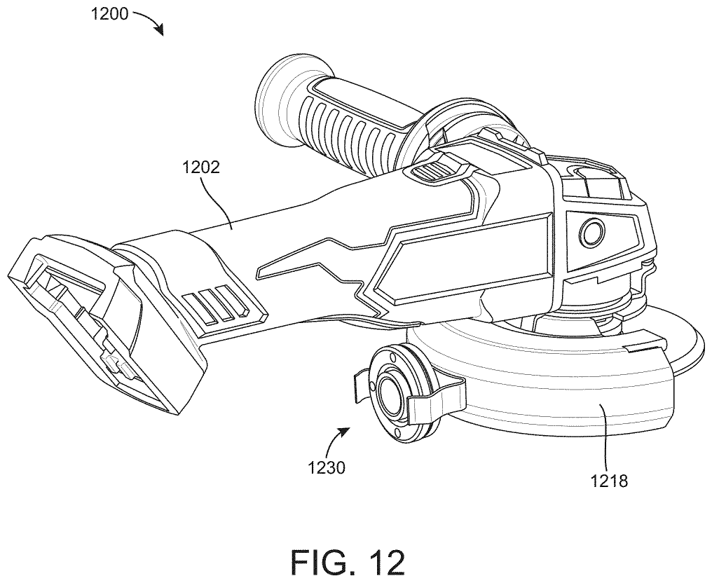

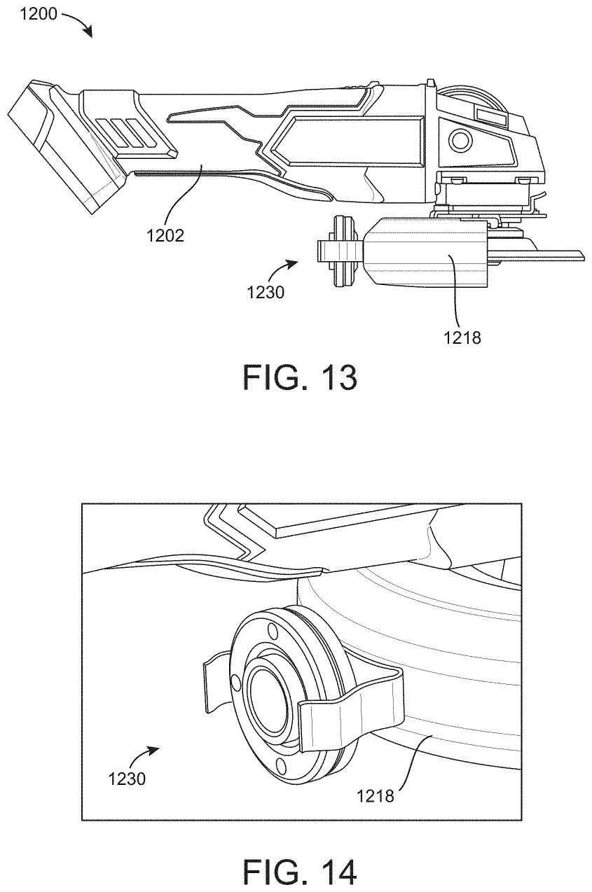

FIGS. 12-14 illustrate another exemplary angle grinder 1200 that is substantially the same as the angle grinder 500 described and illustrated with regard to FIGS. 5-8 except for the placement of the flange retainer 1230. As shown in FIGS. 12-14, the flange retainer 1230 is affixed, or otherwise attached, to the guard 1218 of the angle grinder 1200 (e.g., coupled to an outer peripheral surface of the guard 1218).

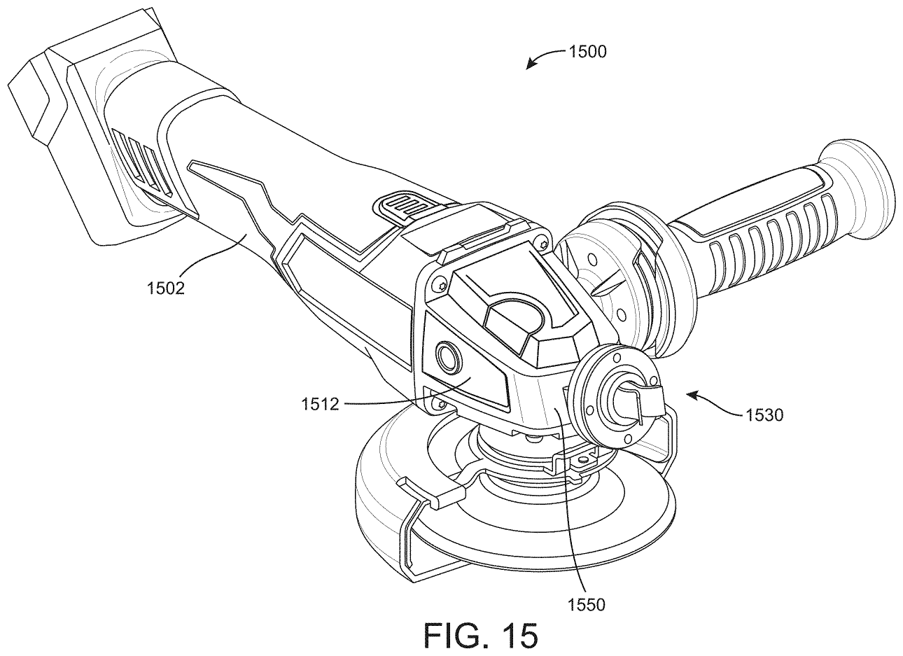

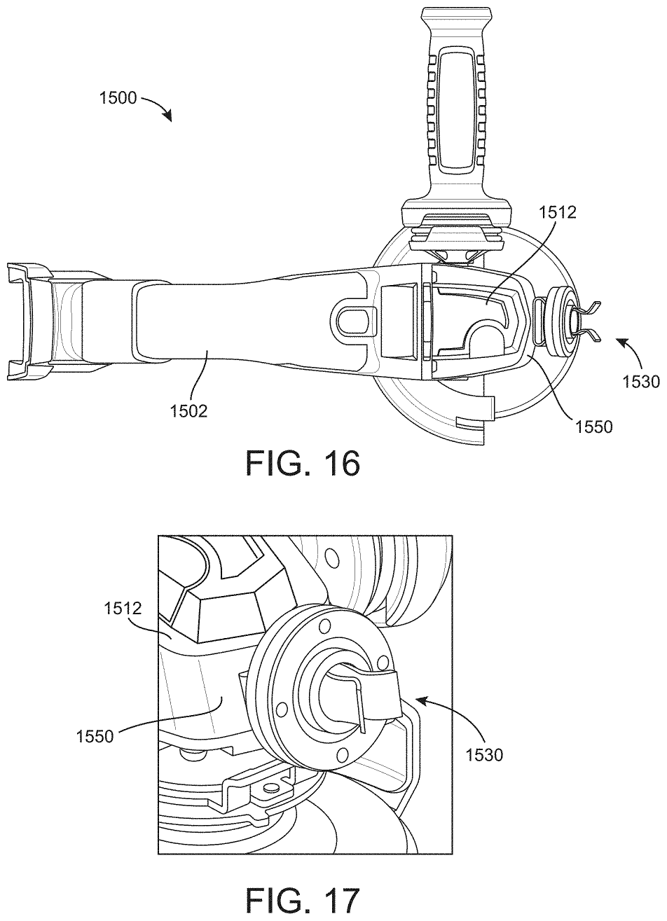

FIGS. 15-17 illustrate another exemplary angle grinder 1500 that is substantially the same as the angle grinder 100 except for the placement of the flange retainer 1530. As shown in FIGS. 15-17, the flange retainer 1530 is affixed, or otherwise attached, to the gearcase 1512 of the angle grinder 1500 (e.g., coupled to an end 1550 of the gearcase 1512).

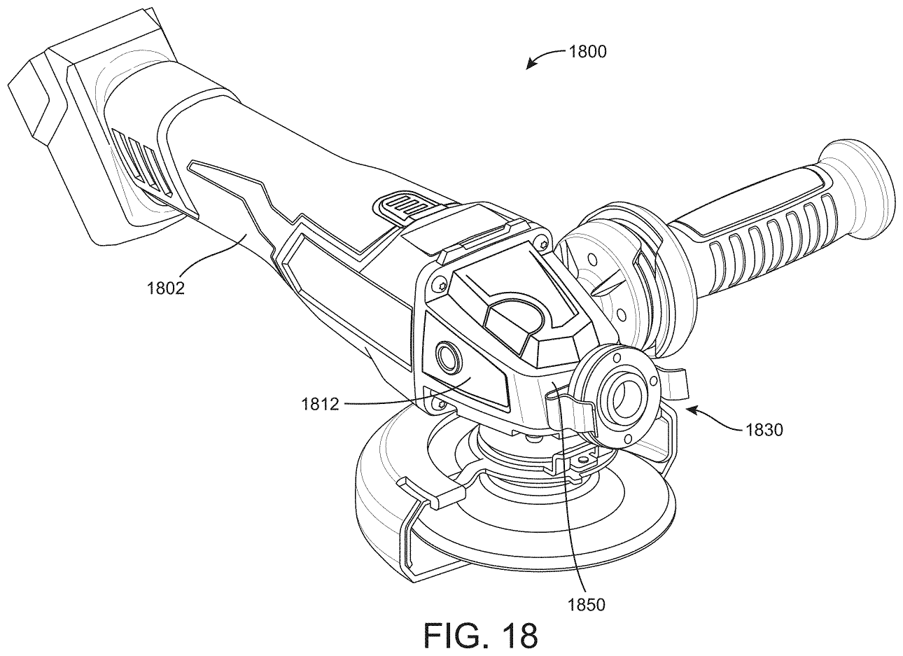

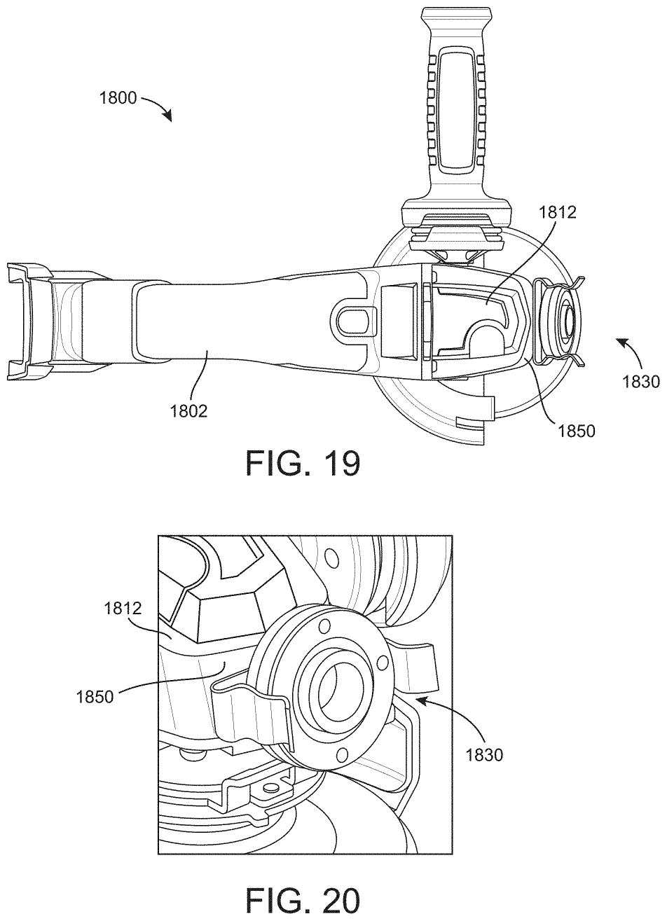

FIGS. 18-20 illustrate another exemplary angle grinder 1800 that is substantially the same as the angle grinder 500 except for the placement of the flange retainer 1830. As shown, the flange retainer 1830 is affixed, or otherwise attached, to the gearcase 1812 of the angle grinder 1800 (e.g., coupled to an end 1850 of the gearcase 1812).

FIGS. 21 and 22 illustrate another exemplary angle grinder 2100. The angle grinder 2100 may be constructed similarly to the angle grinder 100 illustrated in FIGS. 1-4. As shown, a gearcase 2112 of the angle grinder 2100 may be formed with a flange retainer 2130 that includes a pocket 2135 extending from the gearcase 2112 of the angle grinder 2100. For example, the pocket 2135 defines the flange retainer 2130 and may extend from an end 2150 of the gearcase 2112. The flange retainer 2130 may be sized and shaped to receive one or more flanges 2138, 2140 therein. The gearcase 2112, or a portion of the gearcase 2112 that is adjacent or disposed within the flange retainer 2130, may include a magnet to facilitate retention of certain flanges that are ferromagnetic.

FIGS. 23 and 24 illustrate another exemplary angle grinder 2300 that may be constructed similarly to the angle grinder 100 of FIGS. 1-4. As shown in FIGS. 23 and 24, a gearcase 2312 of the angle grinder 2300 may be formed with a flange retainer 2330 that defines a post extending from the gearcase 2312. For example, the flange retainer 2330 may extend from an end 2350 of the gearcase 2312 and may be sized and shaped to receive one or more flanges 2338, 2340. That is, the flanges 2338, 2340 may fit over the flange retainer 2330. The gearcase 2312, or a portion of the gearcase 2312 adjacent the flange retainer 2330 or the flange retainer 2330, may include a magnet to facilitate the retention of certain flanges that are ferromagnetic.

FIG. 25 illustrates another exemplary angle grinder 2500 that may be constructed similarly to the angle grinder 100 illustrated in FIGS. 1-4. As shown in FIG. 25, a gearcase 2512 of the angle grinder 2500 may be formed with a flange retainer 2530 that defines a post extending from the gearcase 2512 around a handle attachment point 2524. For example, the flange retainer 2530 may extend from a side of the gearcase 2512 around the handle attachment point 2524. The flange retainer 2530 may be sized and shaped to receive one or more flanges 2538, 2540. That is, the flanges 2538, 2540 may fit over the flange retainer 2530. The gearcase 2512, or a portion of the gearcase 2512 adjacent the flange retainer 2530 or the flange retainer 2530, may include a magnet that may facilitate the retention of certain flanges that are ferromagnetic.

FIGS. 26 and 27 illustrate another exemplary angle grinder 2600 that may be constructed similarly to the angle grinder 100 illustrated in FIGS. 1-4. A housing 2602 of the angle grinder 2600 may be formed with a flange retainer 2630 that includes a pocket 2635 extending into the housing 2602. For example, the pocket 2635 may extend into a side 2652 of the housing 2602, and the flange retainer 2630 (e.g., the pocket 2635) may be sized and shaped to receive one or more flanges 2638, 2640. That is, the flanges 2638, 2640 may fit into the pocket 2635. The housing 2602, or a portion of the housing 2602 adjacent the flange retainer 2630, may include a magnet that may facilitate the retention of certain flanges that are ferromagnetic.

FIGS. 28 and 29 illustrate another exemplary angle grinder 2800 that may be constructed similarly to the angle grinder 100 illustrated in FIGS. 1-4. The angle grinder 2800 includes a guard 2818 that has or defines a flange retainer 2830 on an upper surface 2856 of the guard 2818. As shown, the flange retainer 2830 may include a magnet, or a magnetic portion, that is incorporated into the upper surface 2856. The magnet of the flange retainer 2830 may facilitate the retention of certain flanges 2838, 2840 that are ferromagnetic.

FIGS. 30 and 31 illustrate another exemplary angle grinder 3000 that may be constructed similarly to the angle grinder 100 illustrated in FIGS. 1-4. The angle grinder 3000 includes guard 3018 that may have a flange retainer 3030 on a lower surface 3058 of the guard 3018. As shown, the flange retainer 3030 may include a magnet, or a magnetic portion, that is incorporated into the lower surface 3058 of the guard 3018. The magnet of the flange retainer 3030 may facilitate the retention of certain flanges 3038, 3040 that are ferromagnetic on the guard 3018 when the flanges 3038, 3040 are disengaged from the spindle of the angle grinder 3000.

FIGS. 32 and 33 illustrate another exemplary angle grinder 3200 that may be constructed similarly to the angle grinder 100 illustrated in FIGS. 1-4. A side handle 3220 of the angle grinder 3200 may be formed with a flange retainer 3230 that defines a pocket extending into or adjacent an end 3254 of the side handle 3220. For example, the flange retainer 3230 may be sized and shaped to receive one or more flanges 3238, 3240. That is, the flanges 3238, 3240 may fit into the pocket of the flange retainer 3230. The side handle 3220, or a portion of the side handle 3220 adjacent the flange retainer 3230, may include a magnet that may facilitate the retention of certain flanges that are ferromagnetic.

It is to be understood that in any of the aforementioned embodiments, the flange retainer may include a spring clip, a magnet, a pocket, or any combination thereof.

As described above, some or all illustrated features may be omitted in a particular implementation within the scope of the present disclosure, and some illustrated features may not be required for implementation of all embodiments. The features described above may be implemented in an order different from the order described above and does not prohibit implementation in another order or combination. While not explained in detail for each embodiment and/or construction, the features of the disclosure described herein may be included on a tape dispenser independent of other features and are not limited to the illustrated disclosure. Embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

Embodiment 1. An angle grinder comprising:

a housing;

a motor disposed in the housing;

a gearcase extending from the housing and including a spindle configured to be rotationally driven by the motor;

a flange removably engaged with the spindle to secure a rotating tool on the spindle; and

a flange retainer disposed on the grinder and shaped to receive and retain the flange when the flange is disengaged from the spindle.

Embodiment 2. The angle grinder of embodiment 1, wherein the flange retainer includes a spring clip extending from the housing and configured to receive and engage an inner diameter of the flange.

Embodiment 3. The angle grinder of embodiment 1, wherein the flange retainer includes a spring clip extending from the housing and configured to receive and engage an outer diameter of the flange.

Embodiment 4. The angle grinder of embodiment 1, further comprising a guard extending from the gearcase, wherein the flange retainer includes a spring clip extending from the guard and configured to receive and engage an inner diameter of the flange.

Embodiment 5. The angle grinder of embodiment 1, further comprising a guard extending from the gearcase, wherein the flange retainer includes a spring clip extending from the guard and configured to receive and engage an outer diameter of the flange.

Embodiment 6. The angle grinder of embodiment 1, wherein the flange retainer comprises a spring clip extending from the gearcase, wherein the spring clip is configured to receive and engage an inner diameter of the flange.

Embodiment 7. The angle grinder of embodiment 1, wherein the flange retainer comprises a spring clip extending from the gearcase, wherein the spring clip is configured to receive and engage an outer diameter of the flange.

Embodiment 8. The angle grinder of embodiment 1, wherein the flange retainer comprises a pocket formed on the gearcase, wherein the pocket is sized and shaped to receive the flange therein.

Embodiment 9. The angle grinder of embodiment 1, wherein the flange retainer comprises a post extending from the gearcase, wherein the post is sized and shaped to receive the flange therein.

Embodiment 10. The angle grinder of embodiment 1, wherein the flange retainer comprises a pocket formed in the housing, wherein the pocket is sized and shaped to receive the flange therein.

Embodiment 11. The angle grinder of embodiment 1, wherein the flange retainer comprises a magnet on the angle grinder and the magnet is configured to engage the flange.

Embodiment 12. The angle grinder of embodiment 1, further comprising a side handle extending from the gearcase, wherein the flange retainer comprises a pocket formed in an end of the side handle and wherein the pocket is sized and shaped to receive the flange therein.

Embodiment 13. An angle grinder comprising:

a housing;

a motor disposed in the housing;

a gearcase extending from the housing and including a spindle configured to be driven by the motor;

a flange removably engaged with the spindle to secure a rotating tool on the spindle; and

a flange retainer disposed on the grinder and defining a spring clip shaped to receive and retain the flange when the flange is disengaged from the spindle.

Embodiment 14. The angle grinder of claim 13, wherein the flange retainer includes a base having a first arm and a second arm each extending from the base.

Embodiment 15. The angle grinder of claim 14, wherein the first arm and the second arm are biased away from each other to retain the flange, and wherein the flange is placed over the first arm and the second arm.

Embodiment 16. The angle grinder of claim 14, wherein the first arm and second arm are biased toward each other, and wherein the flange is retained between the first arm and the second arm.

Embodiment 17. An angle grinder comprising:

a housing;

a motor disposed in the housing;

a gearcase extending from the housing and including a spindle configured to be driven by the motor;

a guard coupled to the gearcase;

a flange removably engaged with the spindle and configured to secure a rotating tool on the spindle; and

a flange retainer disposed on the guard and configured to receive and retain the flange when the flange is disengaged from the spindle.

Embodiment 18. The angle grinder of embodiment 17, wherein the flange retainer includes a spring clip, a magnet, or a combination thereof.

Embodiment 19. The angle grinder of embodiment 17, wherein the flange retainer is disposed on an outer peripheral surface of the guard.

Embodiment 20. The angle grinder of embodiment 17, wherein the flange retainer is disposed on an upper surface of the guard.

Various features of the invention are set forth in the following claims.

1. An angle grinder comprising:
a housing;
a motor disposed in the housing;
a gearcase extending from the housing and including a spindle configured to be rotationally driven by the motor;
a flange removably engaged with the spindle to secure a rotating tool on the spindle; and
a flange retainer disposed on the grinder and shaped to receive and retain the flange when the flange is disengaged from the spindle.

2. The angle grinder of claim 1, wherein the flange retainer includes a spring clip extending from the housing and configured to receive and engage an inner diameter of the flange.

3. The angle grinder of claim 1, wherein the flange retainer includes a spring clip extending from the housing and configured to receive and engage an outer diameter of the flange.

4. The angle grinder of claim 1, further comprising a guard extending from the gearcase, wherein the flange retainer includes a spring clip extending from the guard and configured to receive and engage an inner diameter of the flange.

5. The angle grinder of claim 1, further comprising a guard extending from the gearcase, wherein the flange retainer includes a spring clip extending from the guard and configured to receive and engage an outer diameter of the flange.

6. The angle grinder of claim 1, wherein the flange retainer comprises a spring clip extending from the gearcase, wherein the spring clip is configured to receive and engage an inner diameter of the flange.

7. The angle grinder of claim 1, wherein the flange retainer comprises a spring clip extending from the gearcase, wherein the spring clip is configured to receive and engage an outer diameter of the flange.

8. The angle grinder of claim 1, wherein the flange retainer comprises a pocket formed on the gearcase, wherein the pocket is sized and shaped to receive the flange therein.

9. The angle grinder of claim 1, wherein the flange retainer comprises a post extending from the gearcase, wherein the post is sized and shaped to receive the flange therein.

10. The angle grinder of claim 1, wherein the flange retainer comprises a pocket formed in the housing, wherein the pocket is sized and shaped to receive the flange therein.

11. The angle grinder of claim 1, wherein the flange retainer comprises a magnet on the angle grinder and the magnet is configured to engage the flange.

12. The angle grinder of claim 1, further comprising a side handle extending from the gearcase, wherein the flange retainer comprises a pocket formed in an end of the side handle and wherein the pocket is sized and shaped to receive the flange therein.

13. An angle grinder comprising:
a housing;
a motor disposed in the housing;
a gearcase extending from the housing and including a spindle configured to be driven by the motor;
a flange removably engaged with the spindle to secure a rotating tool on the spindle; and
a flange retainer disposed on the grinder and defining a spring clip shaped to receive and retain the flange when the flange is disengaged from the spindle.

14. The angle grinder of claim 13, wherein the flange retainer includes a base having a first arm and a second arm each extending from the base.

15. The angle grinder of claim 14, wherein the first arm and the second arm are biased away from each other to retain the flange, and wherein the flange is placed over the first arm and the second arm.

16. The angle grinder of claim 14, wherein the first arm and second arm are biased toward each other, and wherein the flange is retained between the first arm and the second arm.

17. An angle grinder comprising:
a housing;
a motor disposed in the housing;
a gearcase extending from the housing and including a spindle configured to be driven by the motor;
a guard coupled to the gearcase;
a flange removably engaged with the spindle and configured to secure a rotating tool on the spindle; and
a flange retainer disposed on the guard and configured to receive and retain the flange when the flange is disengaged from the spindle.

18. The angle grinder of claim 17, wherein the flange retainer includes a spring clip, a magnet, or a combination thereof.

19. The angle grinder of claim 17, wherein the flange retainer is disposed on an outer peripheral surface of the guard.

20. The angle grinder of claim 17, wherein the flange retainer is disposed on an upper surface of the guard.
